(19) United States
(12) Patent Application Publication
(10) Pub. No.: US 2009/0327186 A1
(43) Pub. Date: Dec. 31, 2009

(54) SYSTEM AND METHOD FOR SELECTING CANDIDATES FROM A FAMILY OF CANDIDATES

(75) Inventors: CLAUDIA VIVALDA, NEUILLY SUR SEINE (FR); THOMAS BERARD, PARIS (FR); STEPHANIE SAUNIER, ABINGDON (GB)

Correspondence Address: SCHLUMBERGER CANADA LIMITED, 9450 17TH AVE, EDMONTON, AB, T6N 1M9, CA

(73) Assignee: SCHLUMBERGER TECHNOLOGY CORP., SUGAR LAND, TX (US)

(21) Appl. No.: 12/147,776

(22) Filed: Jun. 27, 2008

(51) Int. Cl. G06N 5/02

(52) U.S. Cl. 706/46

(57) ABSTRACT

A technique facilitates selection of underground substance storage sites. Criteria are established to enable evaluation of a plurality of underground storage sites for storing a given substance. Optimal goals or targets are determined, and the potentially numerous and varied criteria are assessed against those optimal goals. A predetermined rational method is used to process and evaluate the criteria in a manner that ultimately enables selection of a desirable storage site.

### BACKGROUND OF THE INVENTION

A variety of substances can be stored in underground storage sites. For example, substantial current interest exists with respect to carbon capture and storage projects. Substances, such as carbon dioxide, are handled and directed to suitable underground storage. The storage sites can be purposely formed and found naturally occurring in various geological regions.

The desirability of various candidate storage sites can depend on many factors, including the amount and type of substance to be stored. However, many other factors can affect the suitability of specific candidate storage sites. For example, factors related to performance, risk, finances, health, environment, costs and revenues, image, and other factors can have varying degrees of influence over the desirability of a given storage site relative to another. However, there are no adequate techniques for sufficiently evaluating these factors to rank the relative desirability of candidate storage sites and/or to compare selected candidate sites to a determined ideal site.

### BRIEF SUMMARY OF THE INVENTION

In general, the present invention provides a system and method for selecting candidates, such as underground substance storage sites. A set of criteria is established to facilitate evaluation of a plurality of candidates, e.g. underground storage sites for storing the substance. Optimal goals or targets are determined, and the criteria are assessed against those optimal goals. A predetermined rational method is used to process and evaluate the criteria in a manner that provides comparison of different kinds of criteria. The comparison may comprise pair comparison of the different kinds of criteria. The evaluation ultimately enables selection of a desirable candidate, e.g. storage site.

### BRIEF DESCRIPTION OF THE DRAWINGS

Certain embodiments of the invention will hereafter be described with reference to the accompanying drawings, wherein like reference numerals denote like elements, and:

FIG. 1 is a schematic illustration of a family of candidate storage sites and a system for evaluating the candidate storage sites, according to an embodiment of the present invention;

FIG. 2 is a flowchart illustrating one example of a methodology for candidate storage site evaluation, according to an embodiment of the present invention;

FIG. 3 is a schematic representation of one example of a processing system used to process data related to each of the candidate storage sites, according to an embodiment of the present invention;

FIG. 4 is a schematic illustration of a variety of optimal goals or targets that can be stored in the processing system, illustrated in FIG. 3, and against which various criteria may be assessed, according to an embodiment of the present invention;

FIG. 5 is a schematic representation of one example of a hierarchy and the influence of control criteria that are evaluated, according to an embodiment of the present invention;

FIG. 6 is a schematic representation of one example of an aggregation structure used in evaluating candidate storage sites, according to an embodiment of the present invention; and

FIG. 7 is a flowchart illustrating another example of comparing and evaluating candidate storage sites, according to an embodiment of the present invention.

### DETAILED DESCRIPTION OF THE INVENTION

In the following description, numerous details are set forth to provide an understanding of the present invention. However, it will be understood by those of ordinary skill in the all that the present invention may be practiced without these details and that numerous variations or modifications from the described embodiments may be possible.

The present invention generally relates to a system and method for selecting underground substance storage sites. The technique is used to select one or more potential storage sites from a plurality of candidate storage sites. This technique can be used, for example, in carbon capture and storage projects in which storage sites are selected for the storage of carbon dioxide or other substances. Once candidate sites are located, those candidate sites are further characterized to verify certain basic parameters such as having sufficient capacity to store a certain amount of substance, e.g. injected fluid, under acceptable conditions for a sufficient period of time. Storage sites may be naturally occurring, constructed, or a combination of both naturally occurring portions and constructed portions.

The system and method are effective because storage site selection is based on a set of criteria that enable comparison of the candidate sites on a thorough and objective basis. The candidate sites are ranked according to their suitability to meet one or more optimal goals related to, for example, performance, risk, financial considerations, health, environment, costs and revenues, and image. Furthermore, the better a candidate storage site is able to meet the criteria of a predefined storage site, the better that candidate site is able to accomplish its storage function with respect to the established optimal goals. It should be noted that the system and methodology can also be used for other candidate selection applications, such as the selection of an injection well from a class of injection wells. The technique is also useful in assessing the suitability of candidate sites with respect to certain sub-targets/sub-goals relevant to the selection. For example, the methodology can be used with respect to certain aspects of a storage site but not necessarily all aspects.

According to one embodiment, the storage site selection system implements a technique/methodology for selecting candidate sites used to store underground one or more substances, e.g. carbon dioxide, that can be individual substances or mixtures of substances. The system may be a computer-based system able to implement the selection technique. In one embodiment of the invention, the technique is built upon: a set of goals; a set of criteria; a method that permits pair comparison of different kinds of criteria; and an intelligence, such as a processor. The set of criteria is the basis of the evaluation of potential, candidate sites with respect to stated optimal goals or targets. The set of goals is selected according to the specific application and may comprise performance, risk, finance, and target goals, such as health, environment, image, and others, against which the criteria are assessed. The methodology permits pair comparison of different kinds of criteria and may incorporate a variety of predetermined judgments, indexing, and knowledge. The methodology generally comprises a rational method/program, e.g. an analytical program, that can be used to process the criteria and other data. In one embodiment, the rational program used is the Analytical Hierarchy Process and/or the Analytical Network Process. The Analytical Network Process can be employed when dependencies exist among the criteria. The intelligence, e.g. processing system, is used to implement the analytical programs and to enable combination of different hierarchies and criteria to obtain an aggregate measure of the suitability of individual candidate sites to store the desired substance or substances. It should be noted that storage of the substance or substances may be related to a variety of purposes, including permanent disposal, temporary or reversible storage, enhanced/improved oil or gas production, other purposes, or combinations of purposes.

The Analytical Hierarchy Process methodology is based on the innate human ability to use information and experience to estimate relative magnitudes. The Analytical Hierarchy Process derives ratio scales of relative magnitudes of a set of elements by making paired comparisons. Judgments are then made based on the comparisons among the criteria with respect to dominance, which is a generic term for expressing importance, preference, or likelihood of a property they have in common. A ratio scale is derived based on the strength of that dominance. The Analytical Network Process is a multi-criteria theory of measurement used to derive relative priority scales of absolute numbers from individual Judgments. These judgments represent the relative influence of one of two elements over the other in a pairwise comparison process on a third element in the system. The comparison is made with respect to an underlying control criterion. The Analytical Network Process provides a general framework to deal with decisions without making assumptions about the independence of higher level elements from lower level elements and about the independence of the elements within a level, as in a hierarchy. The framework can also be used to determine which of the two elements influences the third element more with respect to a given criterion.

Application of the Analytical Hierarchy Process and Analytical Network Process provides relative results rather than absolute results. The use of these analytical methods enables ordering of the candidate underground storage sites with respect to an optimal goal. By way of example, the Analytical Hierarchy Process and Analytical Network Process methods applied to site selection enable a comparison among candidate underground storage sites of a family that can be assessed according to the same hierarchy built upon the criteria specific to that family and repeated for all hierarchies pertaining to the candidate site family. Generally, family refers to a group of sites that are comparable and can be assessed against the same set of basic criteria. However, comparisons can also be performed among candidate sites of different families by modifying the modalities of application of the Analytical Hierarchy Process and Analytical Network Process methods. Additionally, comparisons can be conducted with respect to families of candidate sites belonging to a particular set of candidate sites and either building a hierarchy of the different site families and assessing them against the overall assessment specific goal or using formulae, criteria, and logic to combine them.

The generic assessment goals, or optimal goals, for underground storage site selection can be classified into categories, such as performance, risk, and finance, that are qualified by characteristics/criteria, such as capacity, injectivity, and containment. The containment assessment is principally dealt with via comparison methods, such as those utilized in the Analytical Hierarchy Process and Analytical Network Process methods.

The criteria for comparison can be classed as quantitative or qualitative. The quantitative criteria are estimated based on available data from measurements, calculations, or expert judgments. Generally, an uncertainty is associated with the criteria values. The Analytical Hierarchy Process and Analytical Network Process methods generally do not deal with uncertainties, however, uncertainties can be accounted for by applying separate methods. In any case, candidate sites that are highly uncertain should not be scored or ranked. Rather, these sites are treated separately by outputting directions to supply additional data that must be recorded, calculated, or estimated as to precise objectives to obtain a sufficient description of the “uncertain” candidate site to enable a new site selection run on the system. Qualitative criteria, on the other hand, are given a qualitative value, such as low, medium, or high. The uncertainty of qualitative criteria may be qualified by statements pertaining to the degree of confidence, e.g. low confidence, medium confidence, and high confidence.

Certain criteria having properties and characteristics, such as capacity and injectivity, can be evaluated with simplified formulae that are functions of relevant physical parameters. In many applications, the relevant physical parameters are not well known at the early stage of the storage site lifecycle. Accordingly, the relevant physical parameters can be estimated from measurements, calculations, and expert judgments. These parameters are sometimes characterized by high levels of uncertainty which is propagated through the formulae to assess their impact on the overall results. The propagation can he performed using a variety of methods, including classical methods and more advanced methods.

Some of the optimal goals for underground storage site selection can be characterized as generic targets and classified into a variety of categories, including health, environment, costs and revenues, and image. Hierarchies can be established for these optimal goals. It should be noted, however, that other generic criteria can be classified separately instead of being assessed against the optimal goals. Examples of such criteria may include regulatory framework and public acceptance. Once all the criteria are assessed, the candidate underground storage sites can be ranked to show the relative level of desirability. In addition, the one or more highest ranked sites can be compared to an “ideal” storage site defined “a priori” for that particular group or family of candidate sites. If any of the highest ranked sites are sufficiently close to the “ideal” that site can be selected for underground storage of the substance or substances.

The Analytical Hierarchy Process and the Analytical Network Process are analytical methods that are known and available. For example, a detailed description of the Analytical Hierarchy Process can be found in Saaty, T. L., Fundamentals of Decision Making and Priority Theory with the Analytic Hierarchy Process, RWS Publications, 2000, Ref: ISBN 0-9620317-6-3. Similarly, a detailed description of the Analytical Network Process can be found in Saaty, T. L., Theory and Applications of the Analytic Network Process: Decision Making with Benefits, Opportunities, Costs, and Risks, RWS Publications, 2005, Ref: ISBN 1-888603-06-2. It should also be noted that other analytical methods presenting similar features can also be used to evaluate the candidate sites based on comparison of criteria between candidate sites as described in greater detail below.

In the embodiment described below, implementation of the technique for underground storage site selection is carried out on a computer-based system in which one or more processors is used to process the various criteria and to carry out evaluation of the criteria pursuant to an analytical program utilizing, for example, the Analytical Hierarchy Process and/or the Analytical Network Process. Although the embodiment described below refers to underground storage site selection, the selection technique can also be used for other applications, such as the selection of an injection well from a class of existing wells, site design, and other applications.

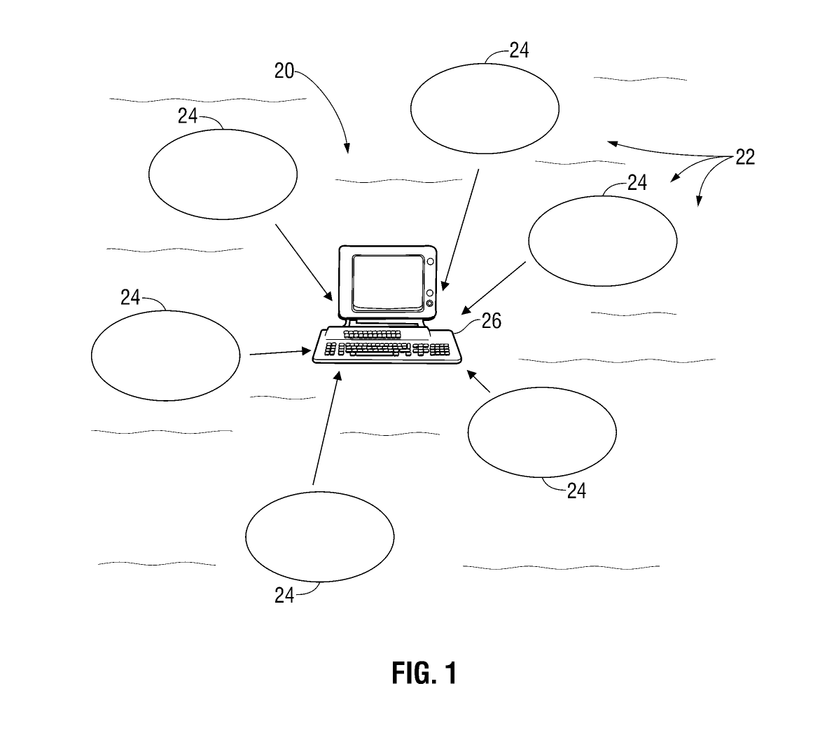

Referring generally to FIG. 1, one embodiment of a system 20 for selecting an underground storage site is illustrated. In this embodiment, a family 22 of individual candidate storage sites 24 is illustrated. Criteria related to each of the storage sites 24 is reduced to data and entered into a processing system 26. The processing system 26 is able to verify that the candidate storage sites 24 meet certain basic conditions, such as sufficient capacity or maximum capacity to store the desired amount of substance. The processing system 26 also is able to carry out one or more rational methodologies for evaluating criteria related to each candidate storage site 24 by, for example, assessing the criteria against optimal goals or targets.

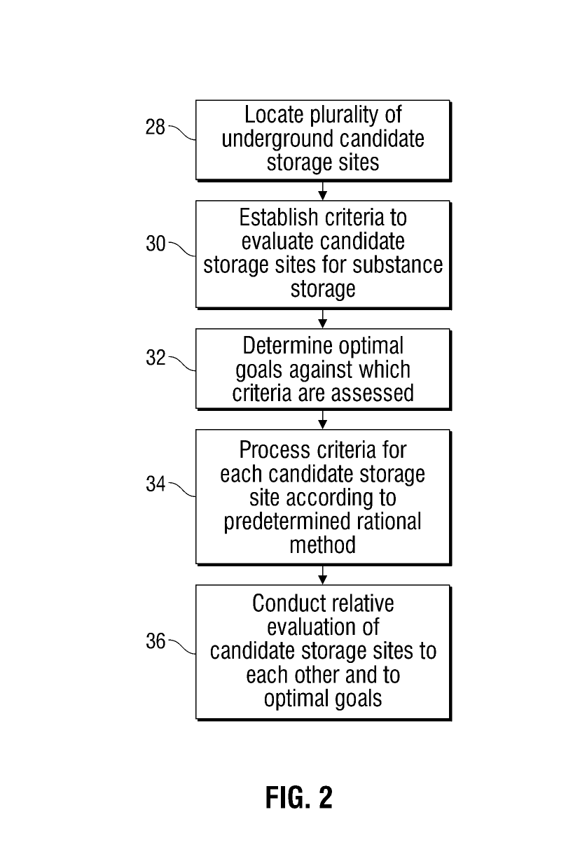

In one embodiment, the present technique can be carried out in conjunction with processing system 26 according to the method outlined by the flowchart of FIG. 2. As illustrated in FIG. 2, a plurality of underground candidate storage sites 24 are initially located, as represented by block 28. Additionally, criteria are established to enable evaluation of the candidate storage sites as to their suitability for substance storage, as represented by block 30. Optimal goals or targets are then determined against which the criteria may be assessed, as represented by block 32. The criteria are processed for each candidate storage site according to a predetermined rational method, e.g. Analytical Hierarchy Process and/or Analytical Network Process, as represented by block 34. During the evaluation, a relative evaluation of the candidate storage sites is conducted to determine a ranking of the candidate storage sites. The evaluation also may involve comparison of all of the candidate storage sites or the higher ranking candidate storage sites to optimal goals that may be embodied in an “ideal” storage site, as represented by block 36.

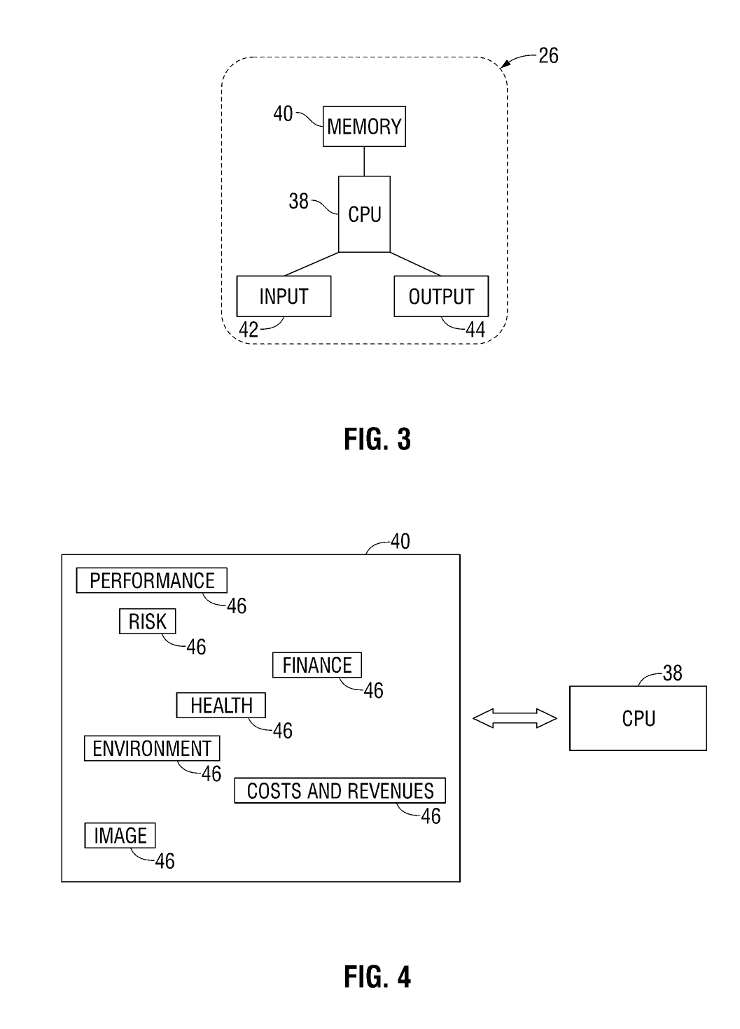

The analysis/evaluation of the criteria and the individual candidate storage sites can be performed on a variety of processing systems, such as computer-based systems having one or more processors located at one or more locations. One example of a suitable processing system is illustrated in FIG. 3. In this example, processing system 26 is a computer-based system having a central processing unit (CPU) 38. Central processing unit 38 is a microprocessor based CPU that enables rapid processing of data/criteria for each of the candidate underground storage sites 24. Furthermore, CPU 38 is operatively coupled to a memory 40, as well as an input device 42 and an output device 44. Input device 42 may comprise a variety of devices, such as a keyboard, mouse, voice-recognition unit, touchscreen, other input devices, or combinations of such devices. Output device 44 may comprise a visual and/or audio output device, such as a monitor having a graphical user interface. The actual processing may be done on a single device or multiple devices.

Memory 40 can be used to store a variety of data along with rational programs for processing the criteria related to candidate storage sites 24. Additionally, the optimal goals 46, e.g. targets, can be stored in memory 40, as illustrated in FIG. 4. Values for individual optimal goals or collective goals used to represent an “ideal” storage site can be stored, and CPU 38 is utilized in assessing criteria from each individual candidate storage site 24 against the various optimal goals 46. By way of example, the stored optimal goal values may relate to performance values, risk values, finance values, health values, environmental values, cost and revenue values, image values, and other optimal goals useful in analyzing candidate storage sites to determine an appropriate storage site for storing the desired substance.

Processing system 26 enables rapid evaluation of criteria and assessment of that criteria against optimal goals according to a rational program, such as an analytical program utilizing the Analytical Hierarchy Process and/or Analytical Network Process. At least some of the criteria to be assessed against optimal goals also can be arranged in analytical hierarchies to enable processing of the criteria according to suitable analytical hierarchy processes such as those found in the Analytical Hierarchy Process and/or Analytical Network Process.

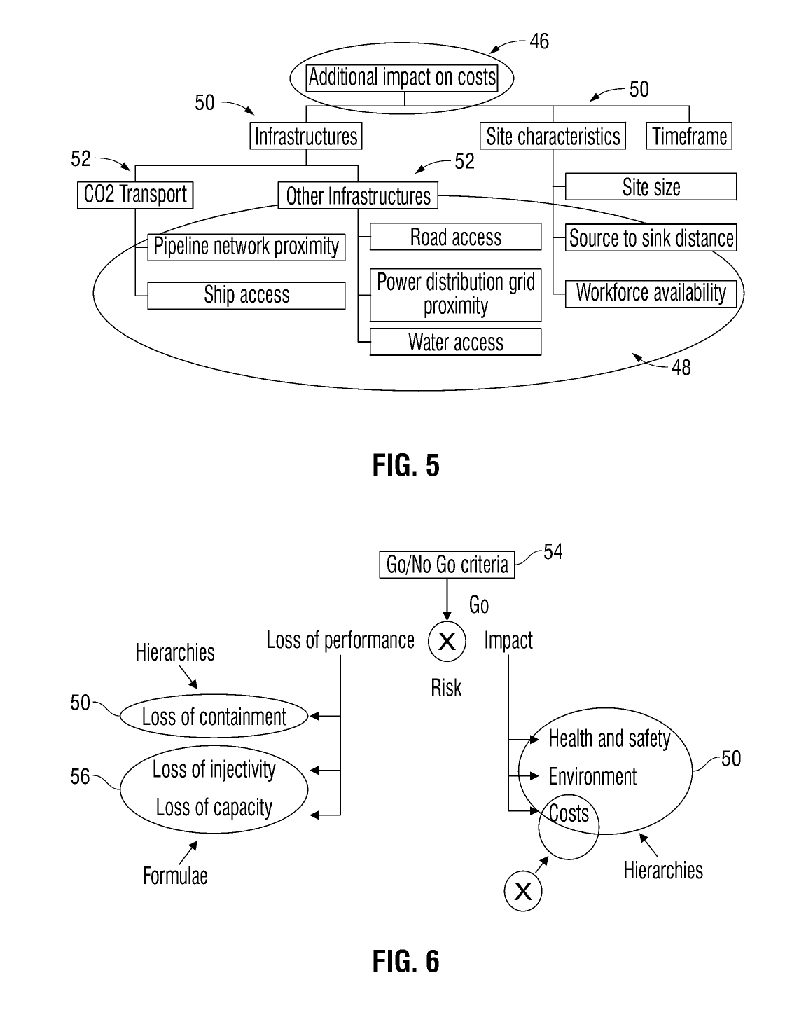

One example of the hierarchical approach is illustrated schematically in FIG. 5. In this example, various criteria 48 are selected to facilitate evaluation of candidate storage sites 24, and those criteria 48 are arranged in hierarchies 50 and sub-hierarchies 52. Values for the criteria and hierarchies can he processed and pair comparisons can be conducted. For example, pair comparisons for the candidate sites 24 can be made against the basic criteria of one hierarchy at a time to produce a ranking of the candidate sites with respect to the optimal goal 46 of the overall hierarchy.

The process can be conducted for a variety of criteria and goals. However, in the example illustrated in FIG. 5, the criteria 48 include pipeline network proximity, ship access, road access, power distribution grid proximity, water access, site size, source to sink distance, and workforce availability. The criteria 48 are used in sub-hierarchies 52 which are related to carbon dioxide transport and other infrastructures. The criteria 48 and sub-hierarchies 52, in turn, are used in hierarchies 50, such as infrastructures and site characteristics. Individual criteria (e.g. timeframe), sub-hierarchies and hierarchies can be used in the overall hierarchy related to the optimal goal 46 which, in this example, relates to the additional impact on costs. However, many other arrangements and uses of the criteria and hierarchies can be processed to assess the various criteria/data against other goals for each of the candidate sites 24.

Criteria 48 can be processed by various rational, e.g. analytical, programs. If, for example, the Analytical Hierarchy Process is used on processing system 26, one example of the pair comparison approach can be described with reference to FIG. 5. For example, the sub-hierarchy 52 labeled “other infrastructures” in FIG. 5 has three criteria to compare, namely road access, power distribution grid proximity, and water access. The candidate sites are pair compared across each of these three criteria. The comparison can be conducted, for example, by determining the answer as to which candidate site has a desired property or better meets the selected criterion as it relates to cost increase due to the presence of other existing infrastructures necessary to or impacting on a storage site, e.g. a carbon dioxide storage site. The second determination is to the degree to which one candidate site has the property or better meets the criterion.

The Analytical Network Process is a multi-criteria theory of measurement that can also be used to evaluate criteria in selecting the desired underground storage site. As described above, the Analytical Network Process is used to derive relative priority scales of absolute numbers from individual judgments. Such judgments represent the relative influence of one of two elements over the other in a pairwise comparison process on a third element of the system with respect to an underlying control criterion. One example of a control criterion is local regulation that can control criteria such as “pipeline network proximity” and “ship access” in the example of FIG. 5. The Analytical Network Process provides a general framework to deal with decisions without making assumptions about the independence of higher level elements from lower level elements and about the independence of the elements within a level as in a hierarchy. In this example, a third question is raised concerning dominance and that question relates to which of the two elements influences the third element more with respect to a given criterion. In FIG. 5, for example, the criteria “pipeline network proximity” and “ship access” can depend on the control criterion “local regulation”. The judgment determined by processing system 26 is the dominance of the “pipeline network proximity” to “ship access” with respect to “cost increase” due to the presence of carbon dioxide transport infrastructures that depend on the “local regulation”. By way of example, the local regulation may require that carbon dioxide is transported through special types of pipelines laid at a certain distance from living areas, therefore making this type of transport less attractive than ship transport.

Referring to FIG. 6, one example of an aggregation structure that can be employed via processing system 26 for processing the various criteria is illustrated. The use of processing system 26 facilitates the aggregating or combining of different hierarchies, criteria, and properties for evaluation in determining the existence of a desired, suitable underground storage site. In this embodiment, go/no go criteria (see block 54) is initially evaluated by, for example, entering specific go/no go criteria into processing system 26. Examples of go/no go criteria include estimated site capacity versus required capacity.

The system can be used to evaluate a goal related to risk, for example, by evaluating other goals, sub-goals, or targets, such as loss of performance and impact. The rational program implementing, for example, the Analytical Hierarchy Process and/or Analytical Network Process can be used to evaluate through pair comparison various criteria, criteria derived through formulae 56, and hierarchies 50. The ability to aggregate the various criteria, durations, and hierarchies for relative comparison between pairs of candidate sites via the appropriate analytical program enables a ranking of the candidate storage sites 24. The processing system 26 can also be utilized to compare specific candidate sites, such as the higher ranked candidate sites, with ideal goals for an overall ideal storage site to determine the ultimate feasibility of specific candidate sites.

Generally, the criteria of each family of candidate sites can be arranged hierarchically with respect to their ability to concur for the achievement of an optimal goal, e.g. site goal or target. Criteria can be used to evaluate properties and characteristics, e.g. capacity and injectivity, by formulae. Select criterion of each hierarchy can be weighted with respect to the upper level optimal goal. The weights of the criteria are independent of the specific site under assessment and are common to families of sites having similar characteristics. The pair comparison of the candidate sites can be conducted against the basic criteria of one hierarchy at a time to produce a ranking of the candidate sites with respect to the optimal goal of that hierarchy. Additionally, various hierarchies, external criteria, and properties can be combined. The combination can be accomplished through a related hierarchy as well as through a formula or logic. Based on the values determined, a final ranking of candidate sites can then be derived in which the candidate sites are ranked from most suitable to least suitable. The ranking can be relative among the candidate sites or absolute. The absolute ranking is based on metrics measuring the closeness of sites deemed suitable for storage relative to an ideal site defined a priori.

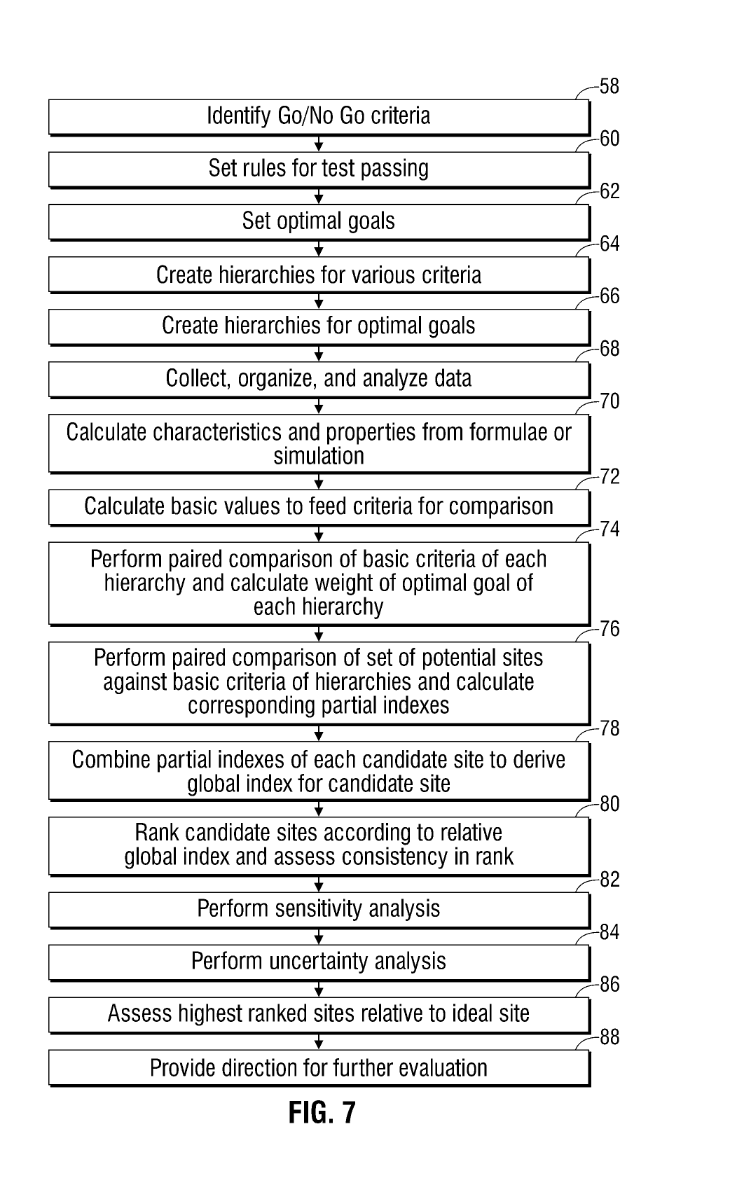

Although the details of the methodology can be adjusted from one application to another, one detailed example is illustrated by the flowchart of FIG. 7. In this example, initial go/no go criteria are identified, as represented by block 58. The go/no go criteria can be used to simplify the comparison process by eliminating candidate sites at an early stage. Rules can also be established for test passing with respect to go/no go criteria and with respect to evaluation of other criteria, as illustrated by block 60. Similarly, optimal goals, including sub-goals and targets, can be set, as represented by block 62.

Subsequently, hierarchies can be created for selected criteria, such as containment, as represented by block 64. This can be performed once for the family of candidate sites, and the same hierarchies can be used each time a subset of sites belonging to the family is assessed. The hierarchies can be updated regularly on the basis of new criteria being introduced or from feedback resulting from their use. Hierarchies can also be created with respect to the optimal goals/targets, as represented by block 66. The data related to the criteria by which each individual candidate site is evaluated can be collected, organized and analyzed, as illustrated by block 68. The processing system can be used to determine criteria, e.g. characteristics and properties, calculated or otherwise derived from formulae and/or model simulations, as represented by block 70. Ultimately, basic values are calculated that can be used by the processing system as criteria for comparison, as represented by block 72.

Once the basic values are created as a result of entered criteria, calculated criteria, hierarchies, etc., a paired comparison can be performed on these basic values for each hierarchy. The comparison enables calculation of a weighting for each hierarchy toward an optimal goal, as illustrated by block 74. In some applications, paired comparison of the set of candidate sites can be performed against the basic criteria of the hierarchies for calculating corresponding partial indexes, as represented by block 76. The partial indexes of each candidate site can be combined to derive a global index for the candidate site, as represented by block 78.

Based on the paired comparisons and/or determination of a global index, the candidate sites are ranked, and the consistency of each candidate site within that rank can be assessed, as represented by block 80. In some applications, a sensitivity analysis (see block 82) and/or an uncertainty analysis (see block 84) can be performed with respect to the criteria assessed against the optimal goals. The sensitivity of the ranking to the evaluation criteria may be obtained as a byproduct. Furthermore, the highest ranked sites can be assessed relative to a predefined site, e.g. an ideal site, to determine whether any of the candidate sites within a given family are suitable for use as the actual underground storage site, as represented by block 86. Depending on the results, the processing system 26 can also be used to output directions regarding further evaluation, as represented by block 88.

The present technique enables the collection and processing of a variety of criteria to facilitate complex evaluation of the criteria and selection of storage sites from a plurality of candidate sites. The criteria can be processed via a variety of formulae, models, hierarchies and combinations thereof. Additionally, various analytical tools can be used to compare pairs of candidate sites to ultimately determine whether individual sites of a family of sites are suitable for a given storage application. For example, the Analytical Hierarchy Process and/or the Analytical Network Process can be used via processing system 26 in ranking and selecting candidate storage sites. These processes are amenable to use with the creation of hierarchies of value for containment and other parameters., e.g. legal framework, public acceptance, and various other parameters. Processing system 26 can be constructed in various forms to provide the intelligence for aggregating/combining the different hierarchies, criteria, and properties. Additionally, various methods of uncertainty analysis and sensitivity analysis can be combined with the Analytical Hierarchy Process and/or the Analytical Network Process to better account for uncertainties surrounding various values used in selecting storage sites.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A method for selecting underground substance storage sites, comprising:
selecting a plurality of candidate sites for storing a substance underground:
using a processor-based system to verify the candidate sites as meeting certain basic conditions;
establishing criteria for comparing the candidate sites;
determining optimal goals against which the criteria can be assessed; and
evaluating the criteria on the processor-based system to rank the candidate sites and to compare the candidate sites to a predefined site.

2. The method as recited in claim 1, wherein using a processor-based system to verify the candidate sites as meeting certain basic conditions comprises verifying the candidate sites have sufficient capacity to store a predetermined amount of the substance.

3. The method as recited in claim 1, wherein determining optimal goals against which the criteria can be assessed comprises determining a performance related goal.

4. The method as recited in claim 1, wherein determining optimal goals against which the criteria can be assessed comprises determining a risk related goal.

5. The method as recited in claim 1, wherein determining optimal goals against which the criteria can be assessed comprises determining a financial goal.

6. The method as recited in claim 1, wherein determining optimal goals against which the criteria can be assessed comprises determining an environmental goal.

7. The method as recited in claim 1, wherein evaluating the criteria comprises ranking the candidate sites relative to each other.

8. The method as recited in claim 7, wherein evaluating the criteria comprises comparing a highest ranked candidate site to the predefined site.

9. A method, comprising:
establishing a set of criteria to evaluate a plurality of underground storage sites for potentially storing one or more substances;
determining optimal goals against which the set of criteria is assessed;
using a processor-based system to automatically evaluate the set of criteria with respect to each underground storage site according to a predetermined rational method; and
comparing the evaluation of each underground storage site to the evaluation of other underground storage sites and to an ideal storage site to select the optimal candidate.

10. The method as recited in claim 9, wherein using a processor-based system to automatically evaluate the set of criteria comprises processing the set of criteria for each underground storage site via an analytical hierarchy process.

11. The method as recited in claim 9, wherein using a processor-based system to automatically evaluate the set of criteria comprises processing the set of criteria for each underground storage site via an analytical network process.

12. The method as recited in claim 9, wherein establishing a set of criteria comprises establishing at least one of formulae, numerical models, and a plurality of hierarchies.

13. The method as recited in claim 9, wherein determining optimal goals comprises determining an optimal underground site performance goal.

14. The method as recited in claim 9, wherein determining optimal goals comprises determining an optimal underground site risk goal.

15. The method as recited in claim 9, wherein determining optimal goals comprises determining an optimal underground site financial goal.

16. The method as recited in claim 9, wherein determining optimal goals comprises determining an optimal underground site environmental goal.

17. The method as recited in claim 9, wherein establishing a set of criteria comprises establishing criteria related to underground storage sites potentially used for carbon dioxide storage.

18. The method as recited in claim 9, further comprising selecting an underground storage site for carbon capture and storage.

19. A system for selecting underground storage sites, comprising:
a computer-based system having an output device and an input device for entering criteria related to individual underground storage sites of a plurality of underground storage sites, the computer-based system having a memory in which optimal goal values are stored and a program by which the criteria are processed to provide a relative comparison of the underground storage sites and a comparison to an ideal site defined a priori.

20. The system as recited in claim 19, wherein the program comprises an analytical hierarchy process program.

21. The system as recited in claim 19, wherein the program comprises an analytical network process program.

22. The system as recited in claim 19, wherein the stored optimal goal values are related to carbon capture and storage sites.

23. A method, comprising:
establishing a set of criteria to evaluate a plurality of candidates from a family of candidates;
determining optimal goals against which the set of criteria is assessed;
using a processor-based system to automatically evaluate the set of criteria with respect to each candidate according to a predetermined rational method; and
comparing the evaluation of each candidate to the evaluation of other candidates from the family of candidates and to a predefined candidate to select the optimal candidate.

24. The method as recited in claim 23, wherein establishing a set of criteria comprises establishing at least one of formulae, numerical models, and a plurality of hierarchies.

25. The method as recited in claim 23, wherein using a processor-based system to automatically evaluate the set of criteria comprises processing the set of criteria for each candidate via an analytical hierarchy process.

26. The method as recited in claim 23, wherein using a processor-based system to automatically evaluate the set of criteria comprises processing the set of criteria for each candidate via an analytical network process.
